(19) United States
(12) Patent Application Publication
(10) Pub. No.: US 2004/0094096 A1
(43) Pub. Date: May 20, 2004

(54) A DEVICE FOR MILKING AN ANIMAL

(75) Inventors: RENATUS IGNATIUS FRANSEN, VLAARDINGEN (NL); KAREL VAN DEN BERG, BLESKENSGRAAF (NL); MARTINUS HUBRECHT VAN LIERE, MAASSLUIS (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, ZUG (CH)

(21) Appl. No.: 10/604,228

(22) Filed: Jul. 2, 2003

(30) Foreign Application Priority Data
Jul. 5, 2002 (NL) 1021014

(51) Int. Cl. A01J 5/04

(52) U.S. Cl. 119/14.43

(57) ABSTRACT

A device is disclosed for milking an animal such as a cow. The device is provided with a teat cup to be connected to a teat of the animal. The teat cup has a liner that divides the teat cup into a teat space and a pulsation space. A milking vacuum unit applies a milking vacuum in the teat space. The milking vacuum unit comprises a milking vacuum source and a milking vacuum shutting-off device for shutting off the teat cup from the milking vacuum. A pulsation vacuum unit applies a pulsation vacuum in the pulsation space. The pulsation vacuum unit comprises a pulse line portion and a pulsator. The device comprises a mounting block, the mounting block comprising the pulse line portion and the mounting block being provided with a first fastening portion for detachably fastening the milking vacuum shutting-off device and with a second fastening portion for detachably fastening the pulsator.

### CROSS REFERENCE TO RELATED APPLICATIONS

This application claims priority from Dutch patent application no. 1021014 filed 5 Jul. 2002, the contents of which are hereby incorporated by reference in their entirety.

### BACKGROUND OF INVENTION

1. Field of the Invention

The invention relates to a device for milking an animal such as a cow.

2. Description of the Related Art

A pulsator for a milking machine is known from UK patent application no. GB 2089638, the contents of which are hereby incorporated by reference in their entirety. The pulsator comprises four valve units in a common housing. Such a construction is highly complex to manufacture and service.

### SUMMARY OF INVENTION

According to the invention, there is provided an improved milking vacuum device for use in a milking machine of the type having a teat cup to be connected to a teat of the animal, the teat cup having a liner that divides the teat cup into a teat space and a pulsation space, and a milking vacuum source for applying a milking vacuum in the teat space. The milking vacuum device comprises a milking vacuum shutting-off device for shutting off the teat cup from the milking vacuum, a pulsation vacuum unit for applying a pulsation vacuum in the pulsation space, the pulsation vacuum unit comprising a pulse line portion and a pulsator, and a mounting block, the pulse line portion being provided on the mounting block, the mounting block comprising a first fastening portion for detachably fastening the milking vacuum shutting-off device and a second fastening portion for detachably fastening the pulsator. Due to the presence of the mounting block it is possible to obtain an extremely compact device, which is easy to manufacture and service.

In a preferred embodiment, the milking machine comprises a robot arm for automatically connecting the teat cup, and the mounting block is capable of being detachably fastened to the robot arm.

According to a further embodiment, the milking vacuum shutting-off device comprises a resilient hose portion and the first fastening portion for the milking vacuum shutting-off device comprises a tube portion for receiving the hose portion. By varying the pressure applied to an annular cavity between the tube portion and the hose portion, the hose portion may be restricted in diameter to selectively shut-off the milking vacuum supply to the teat cup.

In a yet further embodiment the milking vacuum device may comprise at least two mounting blocks, each associated with a teat cup. The mounting blocks may be detachably fastened to each other in a modular fashion and milking vacuum connections for each of the mounting blocks may be arranged to be in communication with one other.

According to an advantageous embodiment of the invention, by providing such a modular construction with individual pulsators on each mounting block, it is possible to individually set the pulsation per teat.

### BRIEF DESCRIPTION OF DRAWINGS

Embodiments of the invention will now be explained in further detail by way of example only with reference to the accompanying figures, in which:

FIG. 1 is a schematic cross-sectional view of a device according to an embodiment of the invention;

FIG. 2 is a schematic perspective view of four mounting blocks disposed side by side with units in a device according to the invention;

FIG. 3 is a schematic cut-out cross-sectional view of a mounting block and a milking vacuum shutting-off device;

FIG. 4 is a schematic cross-sectional view of a transition piece;

FIG. 5 is a schematic front view of a transition piece;

FIG. 6 shows schematically a part of the mounting block with milking vacuum shutting-off valve and pulsator;

FIG. 7 is a schematic perspective view of a pulsator;

FIG. 8 is a schematic plan view of a controllable aperture;

FIG. 9 shows an alternative embodiment of a device according to the invention; and

FIG. 10 is a schematic perspective view of a mounting block of a device according to the invention.

### DETAILED DESCRIPTION

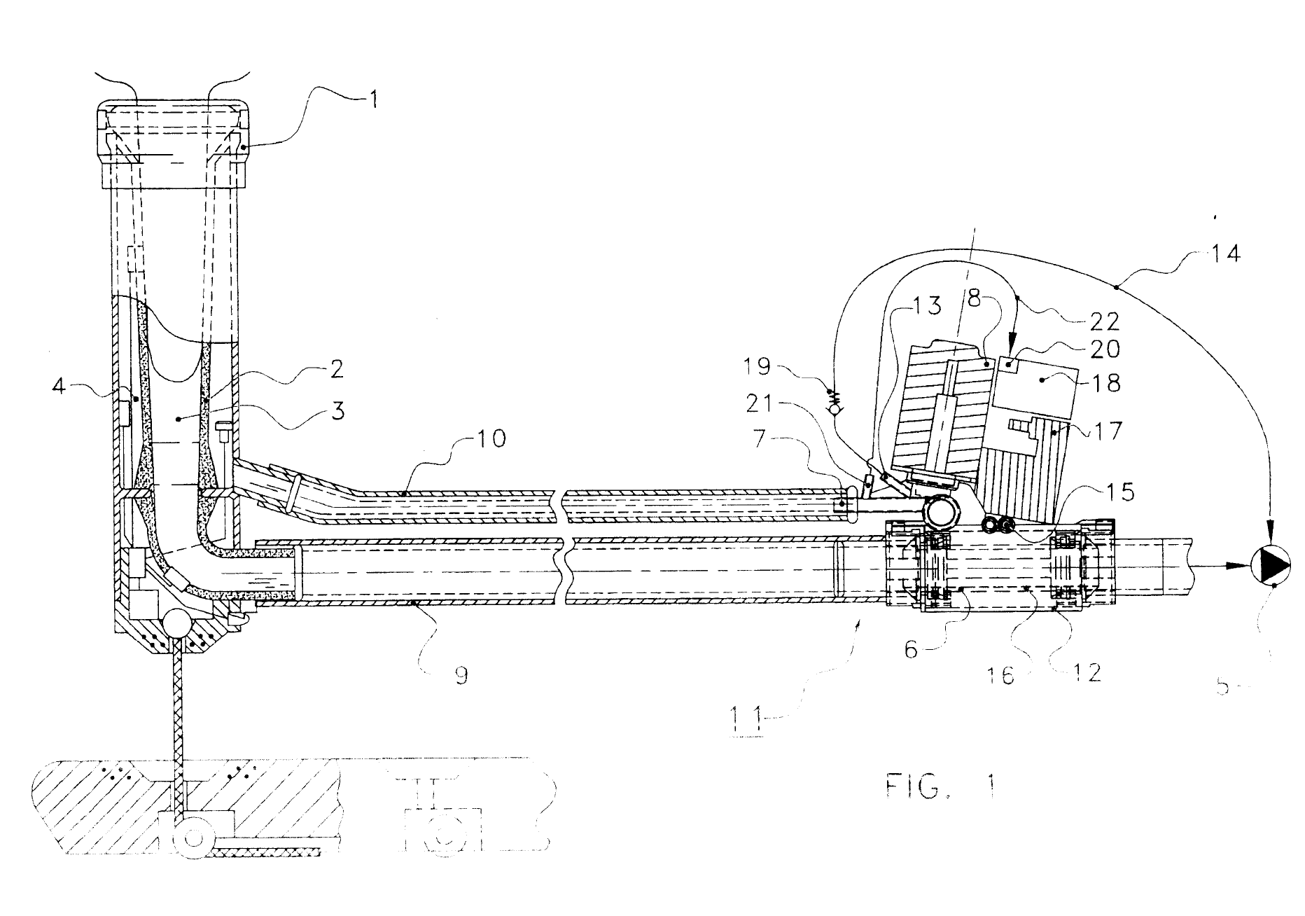

The invention relates to a device for milking an animal such as a cow, a part of which device is shown in a schematic cross-sectional view in FIG. 1. The device is provided with a teat cup 1 to be connected to a teat of the animal. The teat cup 1 has a liner 2 that divides the teat cup 1 into a teat space 3 and a pulsation space 4.

A milking vacuum unit, comprising a milking vacuum source 5 and a milking vacuum shutting-off device 6 for shutting off the teat cup 1 from the milking vacuum, applies a milking vacuum in the teat space 3. For this purpose the milking vacuum shutting-off device 6 can be connected to the teat space 3 via a milking vacuum hose 9.

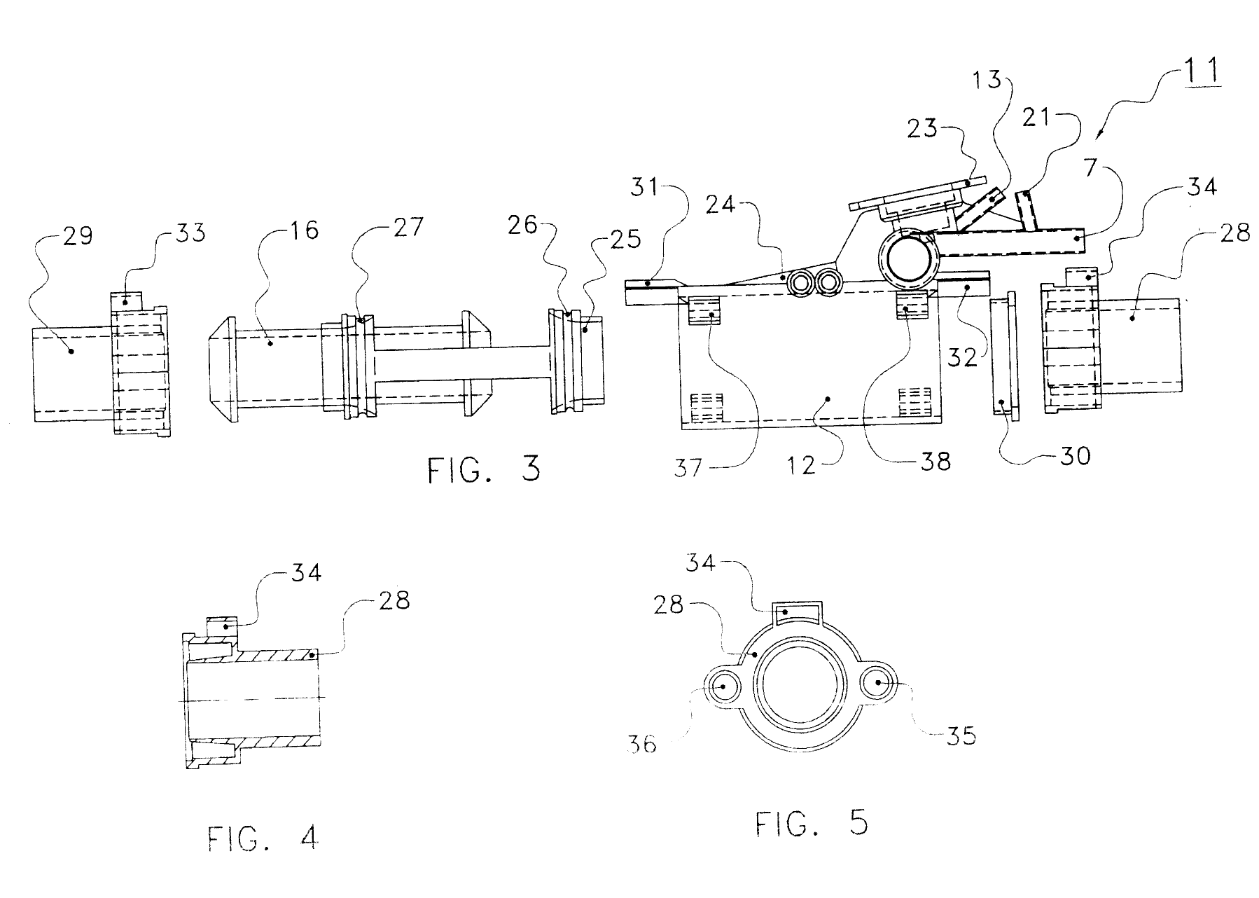

The device comprises a mounting block 11 (see also FIGS. 3 and 10) that comprises the pulse line portion 7 and a first fastening portion 12 for detachably fastening the milking vacuum shutting-off device 6. The mounting block 11 is preferably made of one piece of synthetic material. The mounting block 11 is provided with a milking vacuum connection 13 for the milking vacuum source 5. For this purpose the milking vacuum connection 13 can be connected to the vacuum source 5 via a vacuum source hose 14. The mounting block 11 further comprises a compressed air connection 15 for a compressed air source (not shown).

In the embodiment shown the milking vacuum shutting-off device 6 comprises a hose portion 16 that can be included in the first fastening portion 12, in this embodiment a tube portion. The hose portion 16 can be caused to close or open by varying the pressure in an annular space between the tube portion and the hose portion 16. When the hose portion 16 is open, the teat space 3 is connected to the milking vacuum source 5. When the hose portion 16 is closed, the teat space 3 is disconnected from the milking vacuum source 5, in which case the teat cup 1 is disconnected from the relevant teat of the animal.

The opening and closing of the hose portion 16 is controlled by a controlled milking vacuum shutting-off valve 17. The milking vacuum shutting-off valve 17 (for example a 3/2 valve, such as the Parker P2E KV32C valve) is controlled by a control unit 18 for controlling at least a part of the device. The control unit 18 is detachably fastened to the mounting block 11. The milking vacuum shutting-off valve 17 thus ensures either the connection of the interior of the tube portion to the milking vacuum connection or the connection of the interior of the tube portion to the compressed air connection. For this purpose the mounting block 11 is provided with a first borehole (not shown) connecting the interior of the tube portion to the milking vacuum connection and a second borehole (not shown) connecting the interior of the tube portion to the compressed air connection.

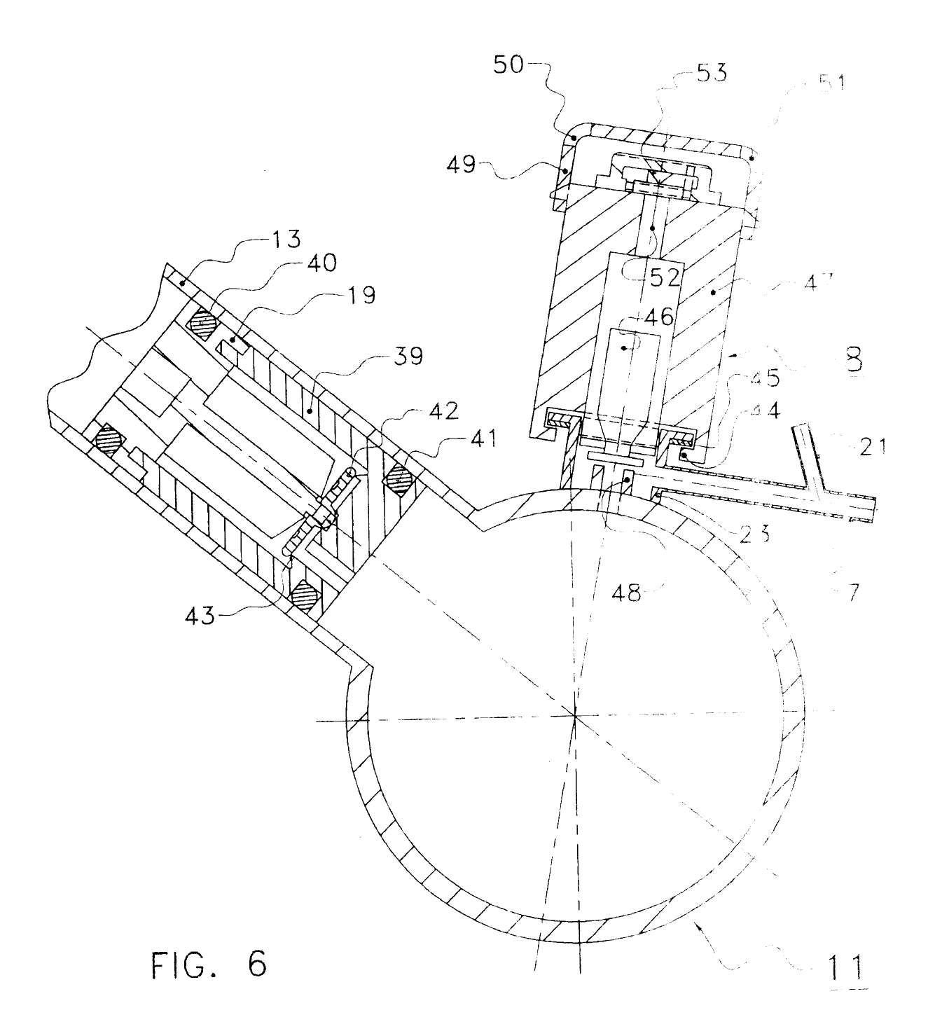

In the connection 13 for the milking vacuum source 5 there is disposed a non-return valve 19 for preventing disturbance of the different pressures. For the sake of simplicity of the drawing, in FIG. 1 the non-return valve 19 is shown in the vacuum source hose 14, which is a possible, but not preferred position. The non-return valve will be set out in further detail hereinafter (FIG. 6).

A pulsation vacuum unit, comprising a pulse line portion 7 and a pulsator 8, is suitable for alternately applying a pulsation vacuum and, for example, an atmospheric pressure in the pulsation space 4. For this purpose the pulse line portion 7 can be connected to the pulsation space 4 via a pulse hose 10. For the purpose of measuring the pressure in the pulsation space 4, for example for checking the pulsation curve, and controlling the pulsation pressure, possibly on the basis of the measured value, the device is provided with a pressure sensor 20 for measuring the pressure in the pulse line portion 7. The pressure sensor 20 is preferably included in the control unit 18, and is therefore detachably fastened to the mounting block. For the connection of the pulse line portion 7 to the pressure sensor 20, the pulse line portion 7 is provided with a sensor connection 21 that is connected to the pressure sensor 20 via a sensor hose 22.

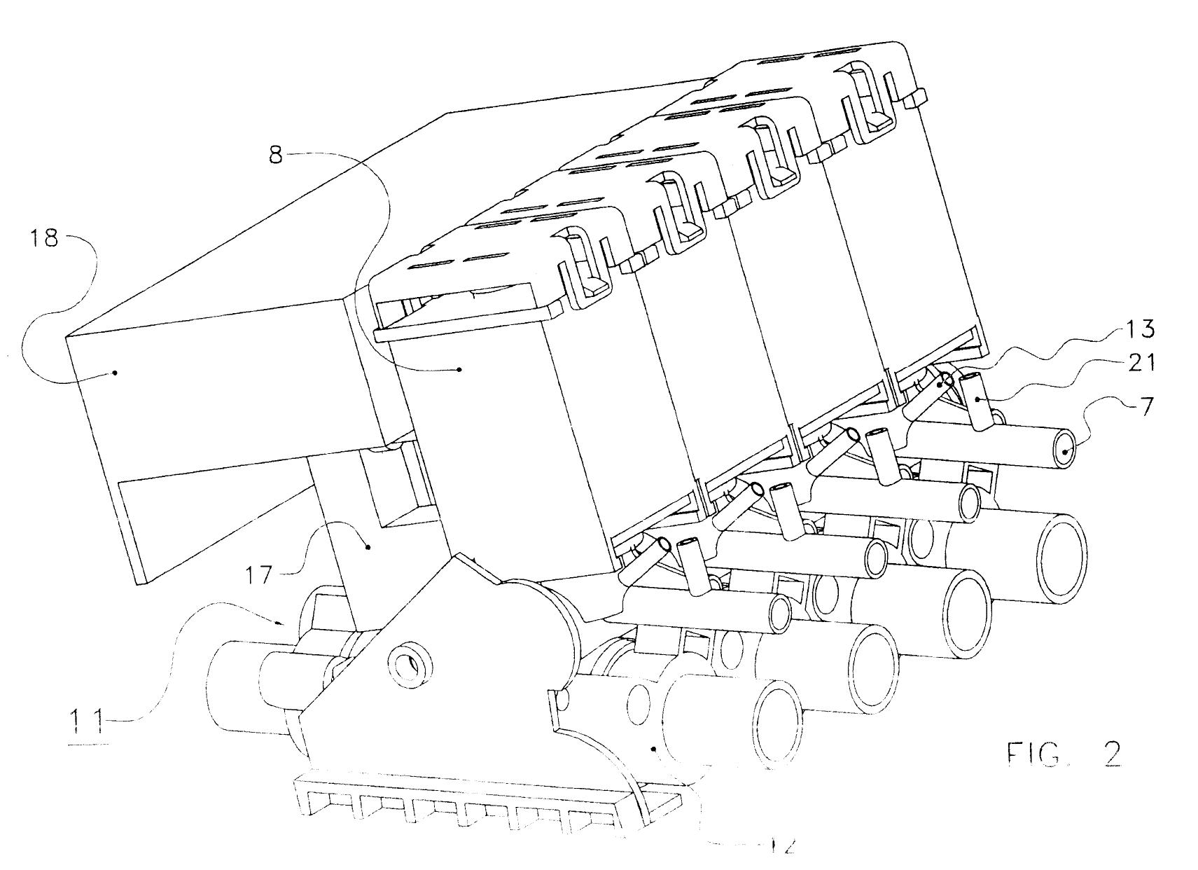

Although the invention may be applied to one teat cup, there are preferably applied at least two teat cups, each provided with an associated mounting block. In that case the mounting blocks are preferably detachably fastened to each other. FIG. 2 shows schematically in a perspective view the mounting blocks 11 including the pulsator 8, the first fastening portion 12, the milking vacuum connection 13, the controlled milking vacuum shutting-off valve 17, the control unit 18 and the sensor connection 21, for four separate teat cups. As is apparent from the drawing, the construction of the entire unit is very compact, while, if the device is provided with a robot arm for automatically connecting the teat cups, the entire unit is capable of being detachably fastened to the robot arm.

FIG. 3 shows schematically in side view a cut-out mounting block 11 with the hose portion 16. The mounting block 11 has a second fastening portion 23 for the purpose of detachably fastening the pulsator 8 thereto. It is further visible that the mounting block 11 is provided with a third fastening portion 24 for the purpose of detachably fastening thereto the milking vacuum shutting-off valve 17. The third fastening portion 24 may be provided with apertures (not shown) through which the milking vacuum shutting-off valve 17 communicates with the milking vacuum shutting-off device 6.

The first fastening portion 12 is a tube portion in which a cage construction 25 can be included in an accurately fitting manner. The cage construction 25 is provided near its ends with grooves 26, 27 for receiving O-rings so that a proper sealing against the inner wall of the first fastening portion 12 can be obtained. The hose portion 16 is inserted into the cage construction 25, in such a way that on both ends a part of the hose portion 16 still projects outward from the cage construction. On these two ends of the hose portion 16 two transition pieces 28, 29 are placed, using an intermediate ring 30, if desired. In FIGS. 4 and 5 such a transition piece 28 is shown in a cross-sectional view, respectively a front view.

For the purpose of locking the transition pieces 28, 29 against undesired rotation, the mounting block 11 is provided with protrusions 31, 32 that are capable of engaging recesses 33, 34 of the transition pieces. Such locking of a transition piece against rotation is extremely advantageous if the transition piece is provided with sensors or detectors for measuring particular milk properties. Such sensors or detectors are preferably embedded in the transition piece which, in that case, is preferably made of synthetic material. For the detachable fastening of the transition pieces, the cage construction and the hose portion, bolts can be inserted into bolt apertures 35, 36, 37, 38 of the transition pieces or the mounting block. The transition pieces are provided with connecting elements on their side that is faced away from the cage construction.

FIG. 6 shows schematically a part of the mounting block 11 in a cross-sectional view (not to scale). FIG. 6 shows the non-return valve 19 in the milking vacuum connection 13 and the pulsator 8 disposed on the second fastening portion 23. For the sake of simplicity of the drawing, the cross sections of the components are depicted in one plane, but, as is apparent for example from FIG. 2, the components are located at some distance from each other.

The non-return valve 19 comprises a casing 39 that is inserted in the milking vacuum connection 13 by means of O-rings 40, 41. The casing 39 comprises a valve 42 and a ring-shaped stop 43 against which the valve 42 can abut in a sealing manner, i.e. in a direction from the milking vacuum connection 13 to the mounting block 11. It will be obvious that, instead of the valve 42, other shutting off means such as a ball or the like could be used as well.

In the embodiment shown, the pulsator 8 is provided with an inwardly projecting edge 44 that engages the second fastening portion 23 in a surrounding manner. By providing a slide connector 45, the pulsator 8 can be detachably fastened to the mounting block 11. The pulsator 8 comprises a plunger 46 that is movable in a reciprocating manner by means of a magnet 47. In dependence on the control, the plunger 46 is movable until it comes into contact with the stop element 48. The movement takes place in a plunger space that communicates with the atmospheric air via a borehole 52. The pulsator 8 is provided with a cover 49 with apertures 50, 51 that surrounds the free end of the borehole 52. The free end of the borehole 52 is provided with a controllable aperture to allow the setting of the so-called C-phase of the pulsation curve. A filter may be included in the cover, if desired.

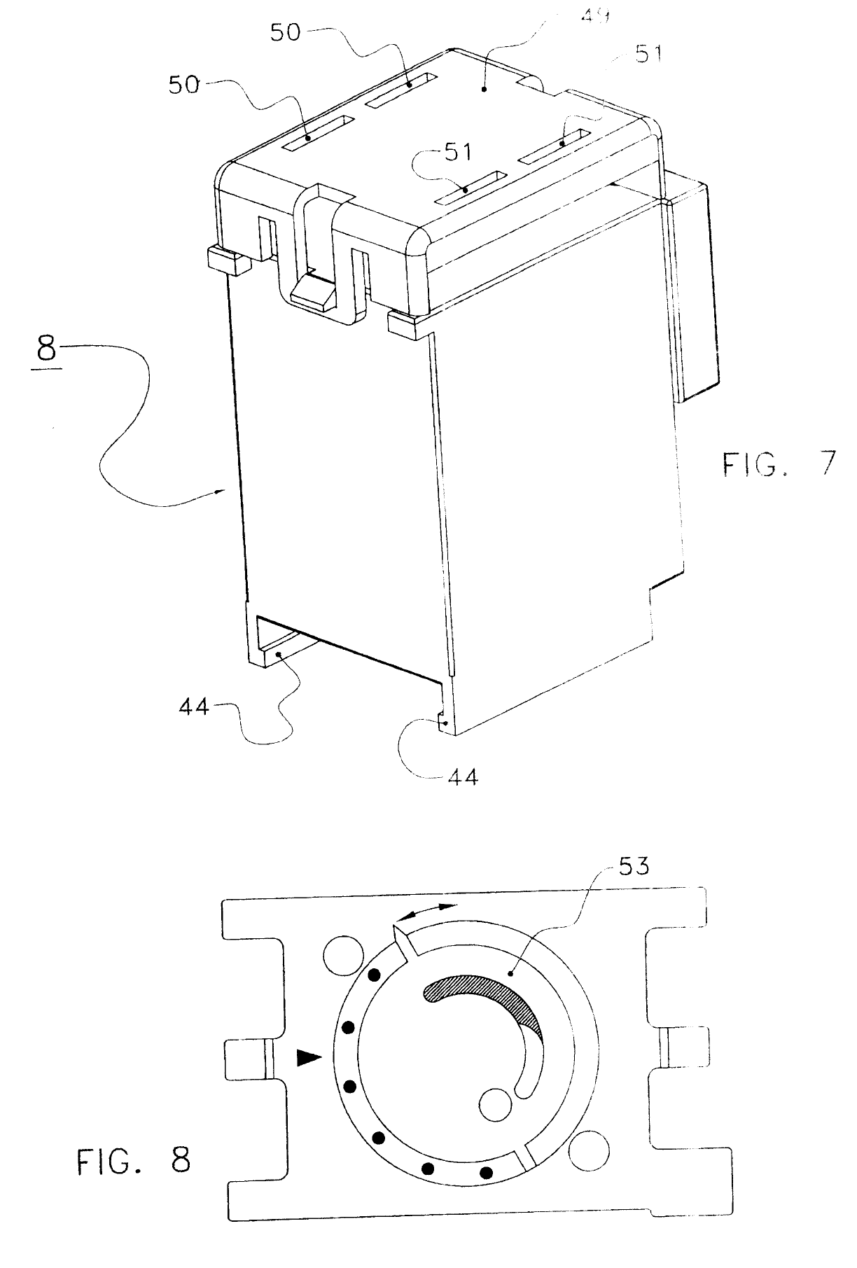

The pulsator 8 is schematically shown in a perspective view in FIG. 7, whereas an embodiment of a controllable aperture 53 is shown in FIG. 8, the size of the aperture being controllable by rotation in the direction of the arrow.

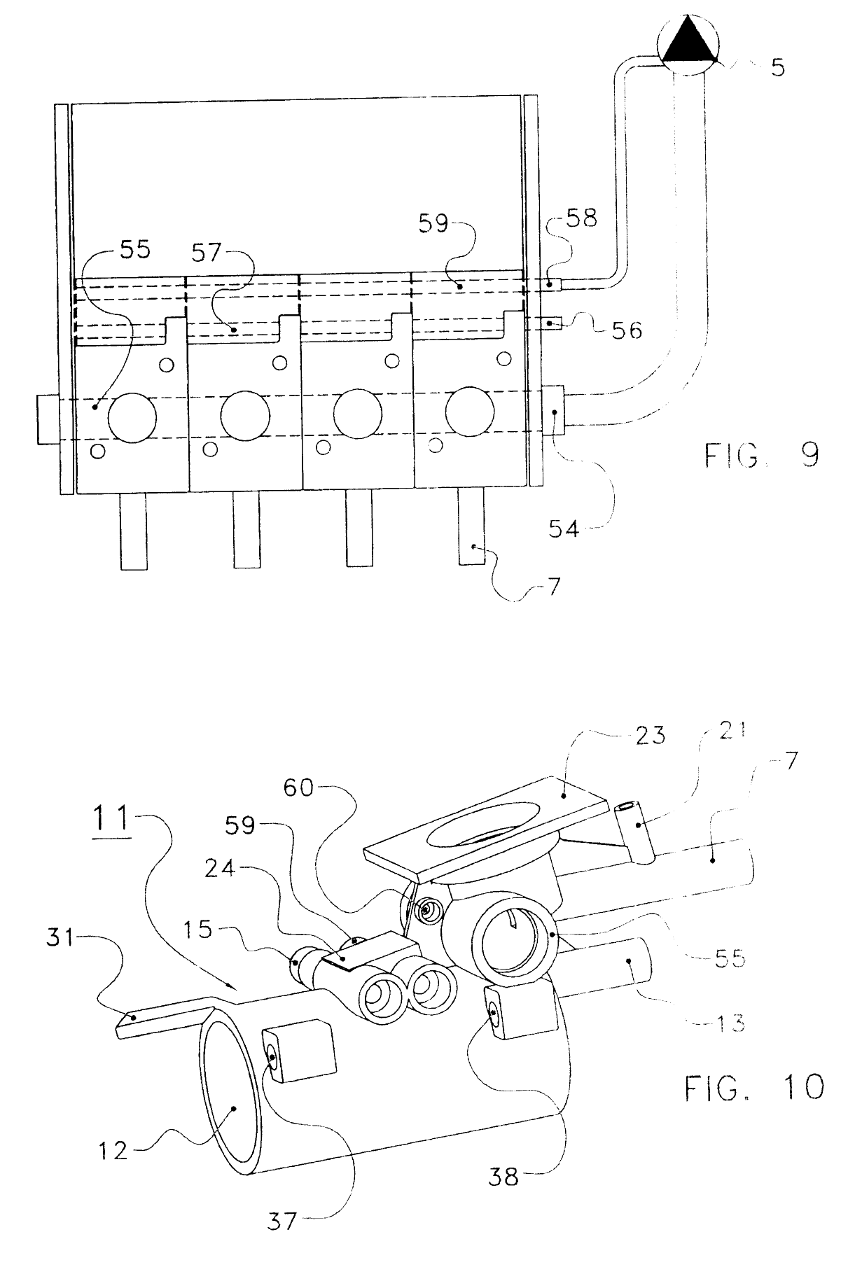

Although there may be provided one separate milking vacuum connection 13 and one separate compressed air connection 15 per mounting block, in some cases it is advantageous if the milking vacuum connections of the mounting blocks are interconnectable by means of a common milking vacuum connection 54 as shown in FIG. 9. In this case each of the mounting blocks has a milking vacuum borehole portion 55 having at its end a milking vacuum connection for being connected to the milking vacuum borehole portion of the adjacent mounting block. Moreover, in an analogous manner, it is possible to realise a common compressed air connection 56, in that each mounting block comprises a compressed air borehole portion 57 and associated compressed air connections that are disposed in line in a position in which the mounting blocks are fastened to each other. If desired, in an analogous manner, in each mounting block there may be provided an extra common milking-vacuum connection 58 and an extra milking vacuum borehole portion 59, for the purpose of preventing possible fluctuations in the milking vacuum controlled by the milking vacuum shutting-off valve.

FIG. 10 shows the mounting block 11 in a perspective view. The figure shows a borehole 60 for receiving a fastening bolt for inter-connecting mounting blocks. It is pointed out here that the milking vacuum borehole portion 55 can be closed.

Because of the fact that the milking process by means of a pulsation vacuum and a milking vacuum is known per se, said process is not set out here in further detail for the sake of simplicity of the description. It will be obvious that, in their assembled position, the relevant components are interconnected in such a way that a customary procedure can be realised. Because of the use of the mounting block and its modular construction, there is achieved a construction which is not only compact but which also enables maintenance and repair, if required, to be carried out in a simple manner.

Many modifications in addition to those described above may be made to the structures and techniques described herein without departing from the spirit and scope of the invention. Accordingly, although a specific embodiment has been described, this is by way of example only and is not limiting upon the scope of the invention.

1. A milking vacuum device for use in a milking machine for milking an animal such as a cow, the milking machine comprising a teat cup to be connected to a teat of the animal, the teat cup having a liner that divides the teat cup into a teat space and a pulsation space, and a milking vacuum source for applying a milking vacuum in the teat space, wherein the milking vacuum device comprises:
a milking vacuum shutting-off device for shutting off the teat cup from the milking vacuum;
a pulsation vacuum unit for applying a pulsation vacuum in the pulsation space, the pulsation vacuum unit comprising a pulse line portion and a pulsator; and
a mounting block, the pulse line portion being provided on the mounting block, the mounting block comprising a first fastening portion for detachably fastening the milking vacuum shutting-off device and a second fastening portion for detachably fastening the pulsator.

2. The milking vacuum device as claimed in claim 1, wherein the mounting block comprises a milking vacuum connection for the milking vacuum source.

3. The milking vacuum device as claimed in claim 2, wherein the mounting block comprises a non-return valve that is disposed in the milking vacuum connection for the milking vacuum source.

4. The milking vacuum device as claimed in claim 1, wherein the mounting block is provided with a compressed air connection for a compressed air source.

5. The milking vacuum device as claimed in claim 4, wherein the milking vacuum shutting-off device comprises a hose portion.

6. The milking vacuum device as claimed in claim 5, wherein the first fastening portion for the milking vacuum shutting-off device comprises a tube portion for receiving the hose portion.

7. The milking vacuum device as claimed in claim 6, wherein the mounting block comprises a first borehole connecting the interior of the tube portion to a vacuum source and with a second borehole connecting the interior of the tube portion to the compressed air connection.

8. The milking vacuum device as claimed in 7, wherein the device is provided with a controlled milking vacuum shutting-off valve for selectively connecting the interior of the tube portion either to the vacuum source or to the compressed air connection.

9. The milking vacuum device as claimed in claim 8, wherein the mounting block comprises a third fastening portion for detachably fastening the milking vacuum shutting-off valve.

10. The milking vacuum device as claimed in claim 1, wherein the device comprises a pressure sensor for measuring the pressure in the pulse line portion.

11. The milking vacuum device as claimed in claim 10, wherein the pressure sensor can be detachably fastened to the mounting block.

12. The milking vacuum device as claimed in claim 1, wherein the milking vacuum device comprises a control unit for controlling at least a part of the milking vacuum device, the control unit being detachably fastened to the mounting block.

13. The milking vacuum device as claimed in claim 1, wherein the mounting block is made of synthetic material.

14. The milking vacuum device as claimed in claim 1, wherein the milking machine comprises at least two teat cups, and the milking vacuum device comprises at least two mounting blocks, each associated with a teat cup.

15. The milking vacuum device as claimed in claim 14, wherein the mounting blocks can be detachably fastened to each other.

16. The milking vacuum device as claimed in claim 15, wherein the mounting block comprises a milking vacuum connection for the milking vacuum source and wherein, in the fastened position, the milking vacuum connections of all the mounting blocks are in communication with each other.

17. The milking vacuum device as claimed in claim 15, wherein the mounting block comprises a compressed air connection for a compressed air source and wherein, in the fastened position, the compressed air connections of all the mounting blocks are in communication with each other.

18. The milking vacuum device as claimed in claim 1, wherein the milking machine comprises a robot arm for automatically connecting the teat cup to the teat and the mounting block is capable of being detachably fastened to the robot arm.
